(19) United States
(12) Patent Application Publication
(10) Pub. No.: US 2003/0131323 A1
(43) Pub. Date: Jul. 10, 2003

(54) Method of schematic-level AMS topology optimization using direct representations

(76) Inventor: Trent Lorne McConaghy, Ottawa (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/337,271

(22) Filed: Jan. 7, 2003

Related U.S. Application Data
(60) Provisional application No. 60/344,808, filed on Jan. 7, 2002.

(51) Int. Cl. G06F 17/50

(52) U.S. Cl. 716/2

(57) ABSTRACT

A method of designing AMS circuits comprises representing circuit design candidates using direct representations such as hyper graphs and storing the direct representations in a database. An optimizer operates on the database of circuit design candidates using an application programming interface to identify optimal circuit design candidates. Views of the circuits, such as schematic or layout views, are provided to a designer. An interface such as a graphical user interface, allows the designer to manipulate the circuit design candidates with corresponding updates to the database during the optimization process so that further optimization steps are based on the updated direct representations in the database that result from the designer's manipulations of the displayed circuit design candidates.

The present application claims convention priority from U.S. Provisional Patent Application No. 60/344,808, filed on Jan. 7, 2002.

### FIELD OF THE INVENTION

The present invention relates to electronic design automation (EDA), particularly the field of analog and mixed-signal (AMS) circuit design.

### BACKGROUND OF THE INVENTION

It is desirable to aid a designer, such as a circuit designer, in solving a design problem, for example, an AMS circuit with an emphasis on front-end design. Front-end design is design at the schematic level and can include the design of the topology and the associated parameters. When the goal includes automatic design of the topology, the problem may be called “structural synthesis of AMS circuits.” This goes beyond mere selection of a topology. Instead, the topology itself is actually designed either from the complete beginning or from initial starting topologies. The semiconductor industry places great value on tools that can speed up the design of a topology in order to solve AMS circuit design problems and “invent” new schematics that humans may not have considered in the space of possible circuits, thus giving better performance, power consumption and lower cost.

Conventional approaches are now described by using examples. These examples include what is currently done in industry, as well as approaches rising out of the literature. FIG. 1 illustrates a fully manual approach 100 to AMS circuit design. The fully manual approach to AMS circuit design is still largely practiced in industry today. Topology selection 110 is done by a user or designer (typically an analog engineer) looking at past topologies that have solved similar circuit design problems. The engineer considers the topologies that have the potential to meet the design objectives and specifications. These topologies can be a company's own internally designed topologies, publicly known topologies such as those in textbooks or topologies licensed from elsewhere. Sometimes, the designer uses a previous topology or topologies as starting points in the design of new topologies, for example, by adding a resistor across two nodes in a previous topology. Once the topology has been selected, the designer proceeds to sizing 120, followed by placement 140 (using SPICE simulator 130), routing 150, extraction 160 and verification 170. Some or all of these other steps may be manual or automatic.

FIG. 2 presents a newer, fully manual approach 200 to AMS circuit design. This approach promotes simultaneous design of the layout and the schematic. The commercial product Cadence™ Virtuoso™ Custom Designer (VCD) supports this approach. The basic idea is that there is one underlying data structure to describe the design, and two views from which the designer can manipulate the data: one for place and route 220, and one for schematic design 120. Note that the place and route block 220 can have elements of automation, such as automatic cell generation or automatic initial placement. Extraction 160 and manual verification 170 are as before.

Two problems with manual approaches to AMS design are the amount of time required and the fact that the resulting designs are sub-optimal. This is especially troublesome because of the shortage of analog engineers in the world, which has caused a backlog of analog and mixed-signal designs waiting to be done. There is value when one can improve upon speed of designs, or improve the designs themselves.

An alternative to manual approaches to AMS design is an automated approach. Automatic sizing of one topology is just beginning to enter the marketplace. In this approach, the designer first manually selects the most promising topology. That topology gets run through an automatic sizing tool and the designer examines the results. If the designer is satisfied with the results, then the designer continues with the rest of the design process. If not satisfied, the designer re-loops to topology selection to try to find the next most promising topology. If necessary, the designer can design a new topology by hand. There have also been research efforts to automated selection of topologies, as well automatic structural synthesis—automatically designing the topology along with the sizing of the topology. As we stated before, there is considerable value in the ability to automatically design the topology itself, because this is often considered the most “inventive” portion of design. Semiconductor companies consider their topologies to be important intellectual property and a source of competitive advantage; an illustration is that on the order of hundreds of topology patents are filed in a given year. Practical automatic structural synthesis of analog circuits is very valuable.

One contributor to the literature regarding automatic structural synthesis of analog circuits is J. Koza. Koza used simulated evolution of tree data structures, which are used as “circuit constructing functions” to automatically design topologies and parameters of analog circuits. In related research, Koza used simulated evolution of tree data structures to automatically design topologies, parameters and layouts of analog circuits. Other researchers in automatic structural synthesis have used a similar framework to Koza: traversing a search space of non-circuit data structures, and converting those data structures to circuits upon evaluation. In all cases, conventional data structures have been used: strings, trees, and matrices. The use of conventional data structures, such as a tree, arises from the historical development of algorithms. Traditionally, a design problem is cast in a form that makes it tractable for an algorithmic approach to solve. For example, when using a genetic algorithm approach, the design problem is cast in terms of strings; when a genetic programming approach is used, the design problem is cast in terms of trees.

However, there are significant drawbacks to these traditional approaches. One problem is that trees are not a completely general representation of designs. Referring to FIG. 12, the set of all possible circuits 1210 depicts all possible circuits viewable and representable in a database, for example, based on a set of initial seed designs and the finite application of operators such as the addition and removal of specified components. The subset 1212 depicts all possible circuits that can be represented as a particular tree data structure designed for structural synthesis. A simplistic example is trees with a limited depth. Another example is the limitations of strings. In a genetic algorithm approach using strings for analog structural synthesis, Jason Lohn reported that his approach was restricted to circuits that could only contain 2-port components. To extend to transistors, Lohn had to “hardwire” transitors into 2-port configurations, e.g. ground wired to drain. There are circuit designs, such as circuit 1202, which cannot be represented as a tree. Accordingly, the use of trees is restrictive and does not enable an optimizer to fully search design space. Note, however, that any circuit in subset 1212, such as circuit 1210, can be represented by the more general approach used in set 1200.

Another major problem is that because there is typically a many-to-one mapping between the conventional data structure of the search space (e.g. trees) and the circuit, transformations between realized circuits and the search space data structure are severely hindered. Specifically, a transformation from a circuit representation to the data structure of the search space is difficult, and usually ill-defined. This means that large “initial topologies” cannot easily be used in this conventional automated structural synthesis—a major problem as most “new” topologies are variants of previous ones. For example, if a known analog circuit has 40 components and a designer desires to vary the circuit to improve performance by applying an optimizer, then the conventional approach requires that the circuit be converted into a conventional representation such as a tree. This, however, is a non-trivial exercise, adding great complexity to the optimizer software, and the conversion still may have no guarantee of success. It also means that during the search, the user cannot examine intermediate results in circuit form and interactively propose changes that the search algorithm can use—also a major problem because designers should be able to exploit their own knowledge in the search process.

### SUMMARY OF THE INVENTION

It is an object of the present invention to obviate or mitigate at least one disadvantage of previous methods associated with known methods of AMS circuit design.

According to an aspect of the present invention, there is provided a method of designing AMS circuits comprising representing circuit design candidates using direct representations such as hypergraphs and storing the direct representations in a database. An optimizer operates on the database of circuit design candidates using an application programming interface (API) to identify optimal circuit design candidates. Views of the circuits, such as schematic or layout views, are provided to a designer. An interface allows the designer to manipulate the displayed circuit design candidates. Changes are captured in the database by making corresponding changes to the direct representations in the database. Further optimization steps are based on the updated direct representations in the database that result from the designer's manipulations of the displayed circuit design candidates.

According to another aspect of the present invention, there is provided a system for designing AMS circuits comprising: storage means for storing direct representations of circuit design candidates; display means for displaying a view of a circuit design corresponding to the stored direct representation; an interface for manipulation of the displayed circuit design resulting in a corresponding change in the stored direct representation thereof; and an optimizer for identifying at least one optimal circuit design from stored direct representation of circuit design candidates, the optimizer responsive to changes in the stored direct representations of the circuit design candidates.

Advantageously, the present invention facilitates the interactive manipulation and attendant control and experiential value of a manual system while enjoying the benefits of automated searching and optimization. Other aspects and features of the present invention will become apparent to those ordinarily skilled in the art upon review of the following description of specific embodiments of the invention in conjunction with the accompanying drawings.

### BRIEF DESCRIPTION OF THE DRAWINGS

Embodiments of the present invention will now be described, by way of example only, with reference to the attached drawings, wherein:

FIG. 1 illustrates a conventional fully manual approach to AMS circuit design;

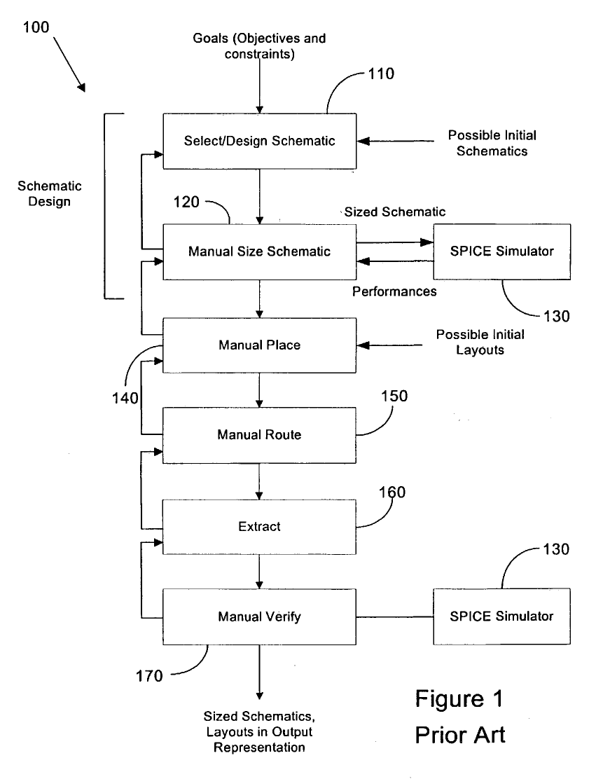

FIG. 2 illustrates another conventional approach to AMS circuit design in which the front-end schematic design process is manual and the back-end design process has manual or automated elements;

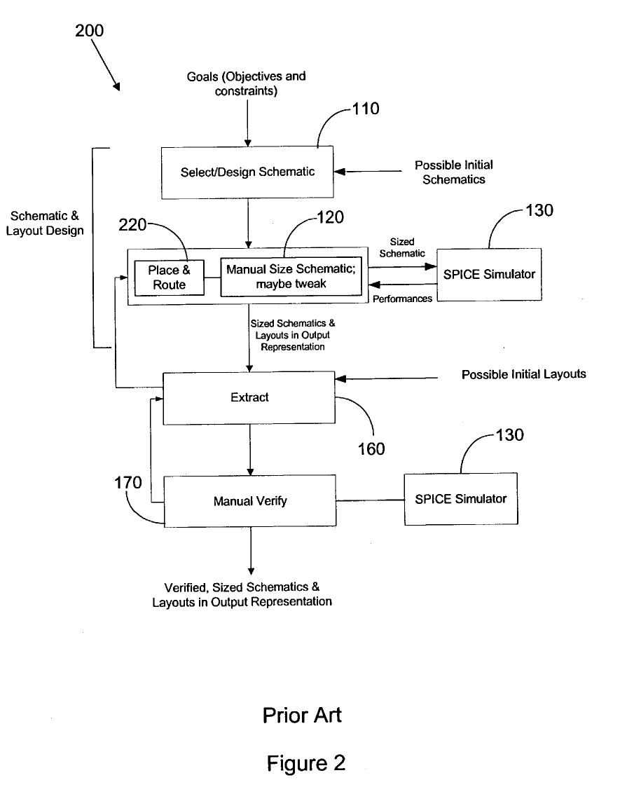

FIG. 3 illustrates schematically steps in the circuit design process according to the invention;

FIG. 4 illustrates an approach an optimization algorithm for use in the circuit design process of FIG. 3;

FIG. 5 illustrates a system according to an embodiment of the invention;

FIG. 6 illustrates schematically the interactions between a designer and the optimizer afforded by the system of FIG. 5;

FIG. 7 illustrates the relationship between a view of a circuit and its corresponding data structure;

FIG. 8 illustrates an example circuit for illustrating a hypergraph;

FIG. 9 illustrates a hypergraph corresponding with the example circuit of FIG. 8;

FIG. 10 illustrates a method according to an example embodiment of the present invention;

FIG. 11 illustrates a method according to an example alternative embodiment of the present invention; and

FIG. 12 illustrates how the breadth of an optimizer design space may not be as comprehensive as circuit space.

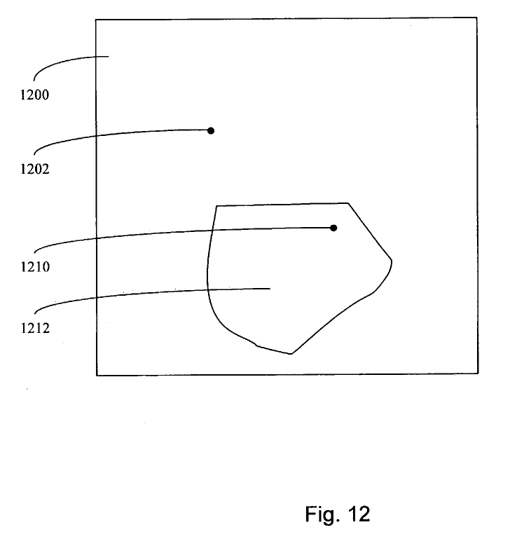

### DETAILED DESCRIPTION

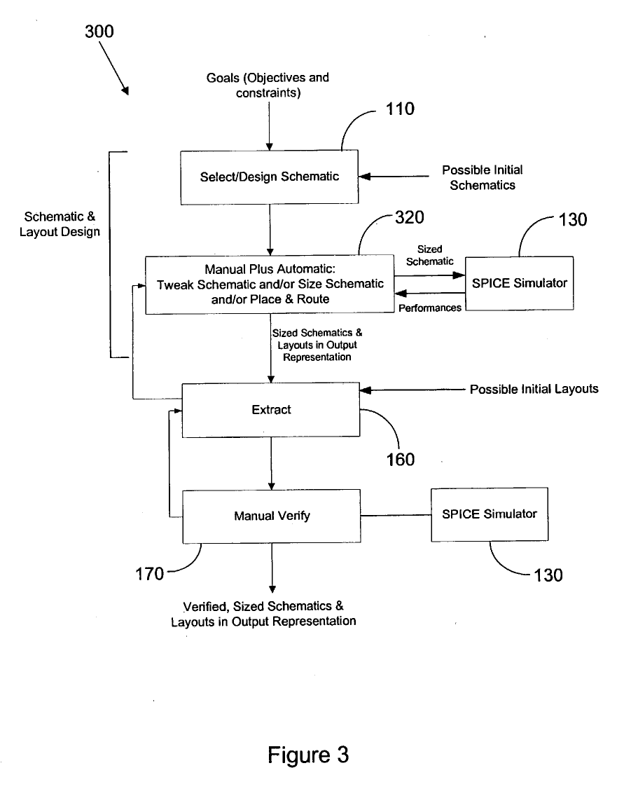

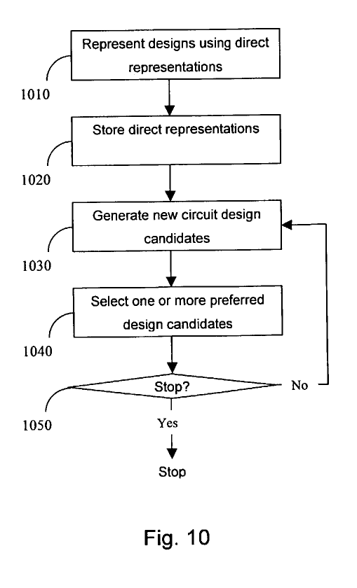

Generally, the present invention provides a method of schematic-level AMS topology optimization. Before discussing the example embodiments of FIGS. 3 to 6 in detail and the associated method of FIG. 10, relevant terminology is discussed.

In the description and claims the following terms are used. A design problem definition is the design space and goals, and an objective function. An objective function is a means of taking in a design candidate and producing performance measures. Evaluation refers to the application of the objective function to design candidates. Goals refer to constraints and objectives. Constraints are conditions that must be met; objectives are conditions to improve as much as possible in light of constraints. For example, in the design of a circuit, an objective might be to minimize power consumption; a constraint might be to have open loop gain greater than 60 dB. Biases are influences on the optimizer's generator and selector mechanisms. For example, initial circuit design candidates can be fed into the optimization algorithm in order to bias the search to preferred solutions or decrease the search time required. Design space is the set of all possible design candidates. Often in structural synthesis, this is defined by a set of initial design(s) plus the set of generator(s) which can be applied to designs. A selector is a mechanism which compares two or more design candidates and selects some, typically using objective function values of the design candidates and biases. A generator is a mechanism which takes as input one or more design candidates and produces one or more new design candidates from those input design candidates. The generator can be a suitable generation algorithm (or its implementation), for example, standard mutation, crossover or Darwinian reproduction algorithms. The generator may have biases.

The expression“optimization” refers to the process of identifying one or more circuit design candidates that are superior to other candidates considered during an (optimization) process or algorithm based on criteria which are typically, although not necessarily, predefined. Although it is desired that the results of the optimization are optimal in a global sense, it is also possible that the circuit design candidates identified by the optimization process represent a “local” optimum or maximum of candidates based on search criteria.

An “optimization algorithm” (also referred to as an “optimizer”) is a search algorithm or process which traverses a subset of the design space (the subset can include the entire design space) with the aim of identifying design candidates having the best or optimized objective function values. In the example embodiments, the optimization algorithm can modify the topology, the parameters, the placement and/or the routing. Thus it is not restricted to parameter optimization (i.e. sizing and biasing). The optimization algorithm proposes new candidate designs, accepts design proposals that the engineer has input and evaluates all candidate designs. Based on the evaluation of goodness of candidate designs, the optimizer algorithm continues to propose new designs.

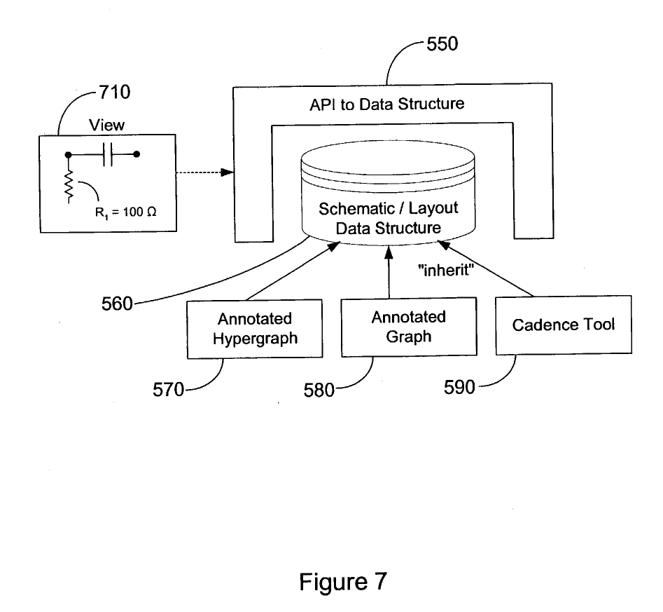

The expression “optimize” is used in a procedural sense of, for example, a search engine employing an optimizer, and not necessarily in an absolute or global sense. Accordingly, when a design is said to have been optimized, it is meant that a search has been conducted and the best results, according to specified criteria, have been identified. This does not, however, guarantee that other better results do not exist or that they cannot be found with additional searching. The expression “designer” generally refers to a person using the optimizer to determine one or more optimized design candidates and is generally synonymous with “user”. It is not used restrictively to a high level designer such as an experienced electrical engineer although it can refer to such. “Schematic” refers to a particular data structure that holds all the data necessary for viewing a circuit topology and simulating it. See, for example, FIG. 7. Note that the search operates on the schematic data structure via the API.

The expression “direct representation” includes data structures that commercial schematic editors use to represent the schematic, or schematic and layout; hyper graphs and graphs, annotated as needed to describe the schematic fully, or the schematic and layout;

structural hardware description language (HDL) text, which is annotated appropriately within comments, etc to handle the extra schematic or layout data that is not part of the HDL syntax; netlist text, which describes parts and parameters, annotated as needed to describe schematic and possibly layout information; and meshes of connections of possible components, with component hook-ups turned “on” and off either via switches, or via very big or very small resistors. This design space may be presented to the optimizer as a set of continuous parameters, or a set of discrete parameters, or both.

Direct representations differ from conventional representations which only capture the basic relationships between components required to allow optimization or searching. Conventional representations do not capture the richness of interrelationships needed for displaying relationships (in one or more views) to a designer who interactively guides the optimization process whereas direct representations do. A good test for “directness” is the question: “Can I convert from my database circuit's representation to my search algorithm's design candidate representation, then back, and end up with the same circuit as before?”

“Schematic information” includes how each component is connected, what the component parameters are, and how the components are placed in (x,y) space. Hierarchical descriptions of circuits can be part of the description.

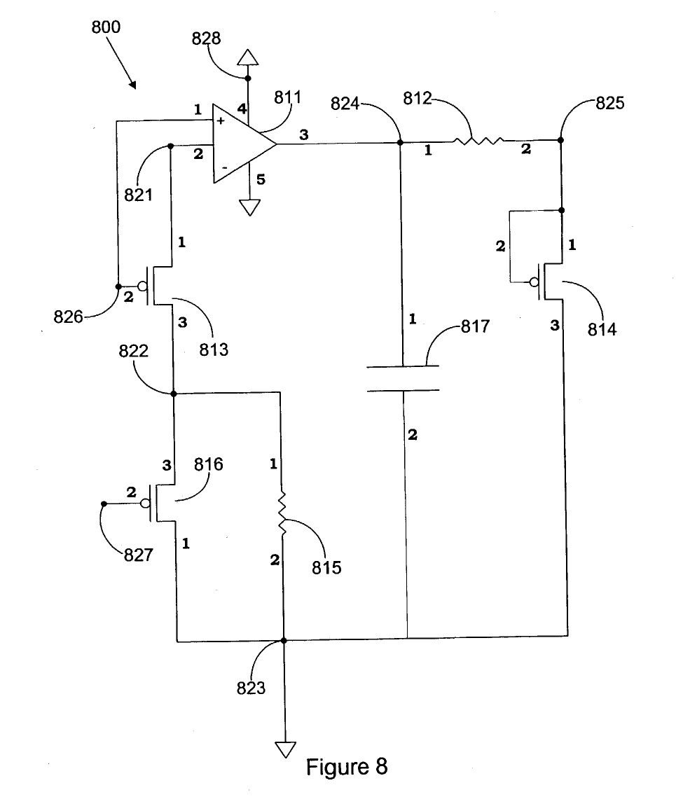

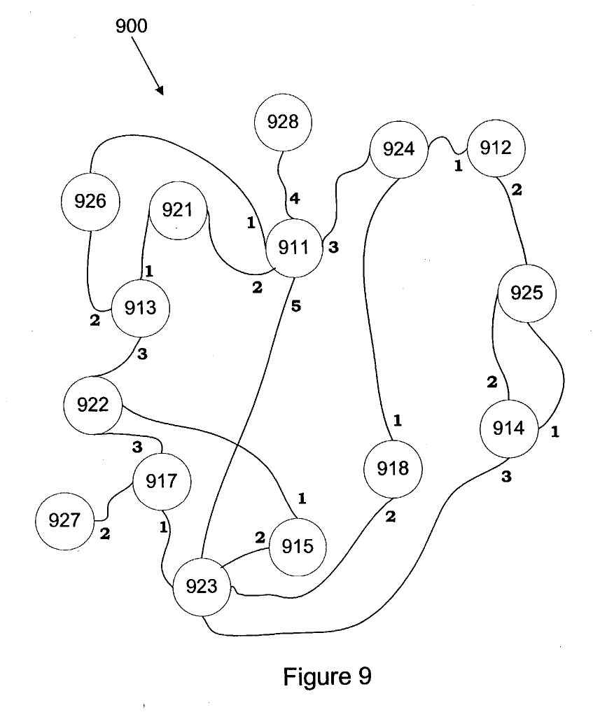

The expression “hypergraph” refers to a generalization of a graph. Two important differences between graphs and hypergraphs are that hyper graphs can have a hierarchical structure and the hyper edges of a hypergraph have one or more “tentacles” or connections. By contrast, edges of conventional graphs always have 2 connections. A hypergraph can represent a circuit as illustrated in the example of FIGS. 8 and 9. An annotated hypergraph holds more information than just the topology information such that schematic information is complete, such as how components are placed in (x,y) space.

FIG. 8 illustrates a circuit 800 using standard conventions for representing functional components 811 to 817 and connections 821 to 827. A corresponding hyper graph 900 is illustrated in FIG. 9 showing hyper graph elements 911 to 917 and hyper edges 921 to 928 and connections by way of tentacles. Note that there is a direct correspondence between components 811 to 817 and the hyper graph elements 911 to 917. Hyper graph elements can be terminal or non-terminal. The difference is that a non-terminal hyper graph element can be expanded (to another hyper graph) whereas a terminal hyper graph element cannot be expanded because there is no lower level. For example, hyper graph element 911 could be a non-terminal hyper graph element representing another hyper graph in a hierarchical fashion. There is also a direct one-to-one correspondence between connections 821 to 827 and hyper edges 921 to 927.

In a hypergraph representation, it is permissible for two ports of the same hypergraph element to go the same hypergraph edge. For example, in FIG. 9, there are two ports emanating from hypergraph element 914 with corresponding tentacles numbered 1 and 2 both of which are connected to hyper edge.

The present invention involves the coupling of an optimization algorithm with a direct representation of the circuit being designed. The optimization algorithm traverses the space of the direct representations to find optimal circuits. The present invention is not constrained to any specific optimization algorithm. Any algorithm which can traverse the space of possible circuits as given in the representations can be used. The algorithm uses a set of operators that it can apply to candidate circuits, in order to come up with new candidate circuits. Different algorithms can be applied depending on the characteristics of operators are needed for the different representations. The only constraint on the type of operators is that they must be able to change the data within the circuit representation in some manner. An example operator is “add a resistor with a fixed resistance R₁ to random pre-existing circuit nodes, and place the resistor's (x,y) location on the schematic randomly.” The actions that an analog engineer would perform on the schematic or the layout are a subset of the possible operators that may be applied.

The present invention is not constrained to any specific type of representation. Any representation which supports “direct mappings” can be used. That is, the method of the present invention must be able to map input circuits into at least one of the representation types. The representation types must be able to map to each other in at least some of the time. And, the representation types must be able to map into output circuits. The input and output circuits may be just descriptions of schematics, or descriptions of both schematics and layouts.

In the “meshes of connections” representations, any optimization algorithm that can handle parameters can be used. If the parameters are continuous, algorithms such as classical gradient-based search algorithms can even be used. If the parameters are just discrete or integers, many integer-programming techniques can be applied. Of course, one can apply more general algorithms to these parameter-based representations as well, such as stochastic hill-climbers, evolutionary algorithms, simulated annealing, tabu search, A-teams, and hybrid methods. In the other representations, the choice for algorithms is more constrained. Algorithms that are relatively independent of the traversal operators used are needed. Such algorithms include evolutionary algorithms, simulated annealing, tabu search, A-teams, and hybrid methods.

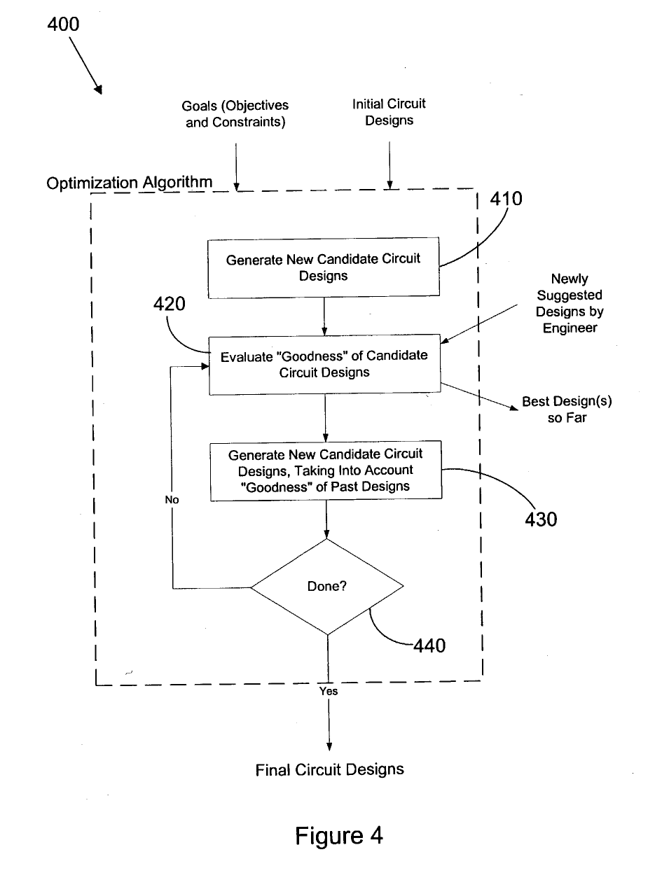

According to embodiments of the present invention, an example circuit design process is schematically illustrated in FIG. 3. Note in particular, the block labelled “Manual Plus Automatic” 320 which incorporates schematic sizing, placement and routing. This process, especially if automated or containing an automated component, typically relies on an optimization algorithm. An example of an optimization algorithm 400 is illustrated in FIG. 4. The optimization algorithm 400 takes as inputs goals and initial circuit design candidates. The first step is to generate new circuit design candidates 410. Next, each candidate circuit is evaluated 420, for example, by an objective function that measures the “goodness” or desirability of each circuit design candidate, by assigning to the circuit design candidate a objective function value(s) or score(s). Next, new circuit design candidates are generated 430, taking into account the objective function values (“goodness”) of past designs.

The next step 440 is to determine whether stopping criteria have been satisfied. These can be, for example, the identification of one or more circuit design candidates which meet a predetermined threshold of “goodness”, the identification of a required number of acceptable circuit design candidates or the execution of a predetermined number of iterations of the algorithm. If the stopping criteria are satisfied then the final circuit design candidates are selected from among the circuit design candidates based on, for example, objective function values. If the stopping criteria are not satisfied, then the algorithm executes another iteration and the “goodness” of each candidate circuit design is evaluated and additional new candidate circuits are generated based on the goodness of past designs. It can also be possible for the designer to stop the optimization algorithm interactively by issuing an appropriate command, for example, if the designer feels that the optimization algorithm will not converge.

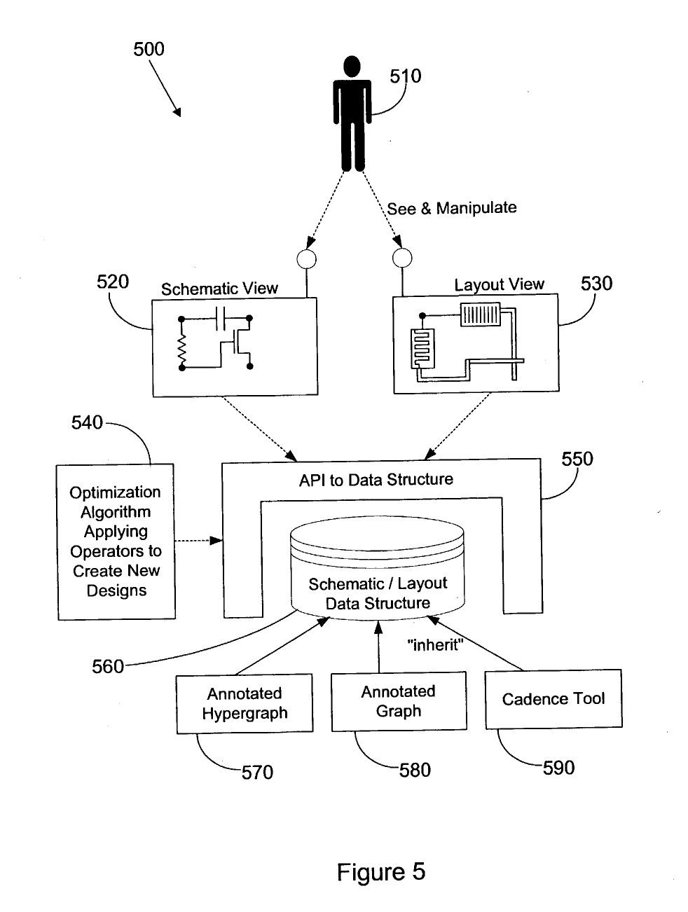

FIG. 5 illustrates a system according to an embodiment of the present invention. The system 500 for designs, specifically analog circuit design provides a direct representation which the circuit designer can see and manipulate and which the optimizer can “see” and manipulate. By contrast, conventional systems which are typically not interactive automated systems do not require (and do not use) direct representations. Instead, conventional representations are used to allow an optimizer to run. Such conventional representations focus on the requirements of the optimizer to optimize the design rather than providing a suitable (direct representation) display which enables the designer to interactively access, manipulate and guide the optimization process as it is conducted by the optimizer. The example of FIGS. 8 and 9 illustrate the direct representation of the circuit 800 by the hyper graph 900. Referring to FIG. 5, system 500 for analog circuit design includes a storage means such as database 560 for storing direct representations of designs. These representations can, for example, be embodied as annotated hyper graphs 570, annotated graphs 580 and representations such as those used in commercial tools, e.g. Cadence™ database format 590.

As illustrated in FIG. 5, a designer 510 has access to see and manipulate the database. A direct representation of the designs is used to provide a one-to-one correspondence between each design candidate stored in the database and a design represented to the designer in a view. Display interfaces allow the designer to work with different views. Each of these interfaces provide views of circuit design candidates by using appropriate symbols and conventions. The display interfaces can also receive commands by a designer 510 to manipulate the characteristics of the circuit design candidates by manipulating the representations of the design candidates. The designer can work with more than one view, for example, both a schematic view and a layout view. Of course, additional views or alternative views can be used. For example the schematic graphical user interface 520 provides a schematic view and a layout graphical user interface 530 provides a layout view.

A database interface such as an application programming interface (API) 550 is used to manipulate the direct representations of circuit design candidates in the database, for example, in response to the designer's commands. Accordingly, the system 500 allows an interactive design approach by designer 510. The designer can interactively alter data structures via views which can then immediately be incorporated into the search. This speeds up design and increases the designer's control over the design process, a result that cannot be achieved by conventional approaches.

The system also includes an optimizer 540 (i.e. the hardware and software implementation of an optimization algorithm which is part of an automated or partially automated iterative design process) which accesses the circuit design candidates in the database via the database interface 550. The optimizer 540 is typically a search engine which manipulates and acts on the schematics in the database to determine the most suitable candidates during the design process. In order to process the candidate designs in the database, the optimizer has read access to the database to be able to determine the status of the database and current search results. It is in this sense that the optimizer “sees” the database. Referring to FIG. 5, this achieved through the API associated with the database. The optimizer also requires write access to operate on or manipulate the current search to allow evolution of the design candidates towards the final search results.

Accordingly, a change to a design in the database results in a change in the visual display of the design presented to the designer. More importantly, however, a change made by the designer during optimization is reflected by a corresponding change in the database, which affects the future activity of the optimizer. For example, a designer presented with a display such as that of FIG. 8 via an interactive graphical user interface can use a pointing device to select and delete a component such as resistor 812. Referring to FIG. 9, the corresponding node 912 in the direct representation of the circuit of will also be deleted and the optimizer will use the resulting modified circuit for future processing. Similarly, the designer can add additional components or groups of components by graphical user interface tools such as “drag and drop” or selection from a menu and replace existing components by other components or groups of components. The designer also has the ability to change the relationships between components, for example, by changing the points of connection of a resistor. In an alternative view, the designer can also change the values associated with any component including such as the resistance of a resistor, the physical size of a component or the physical location of the component.

Typically, the system 500 enables an iterative design process that repeats until a suitable stopping condition is realized. During the process, the optimizer examines design candidates under consideration and selects or otherwise operates on the candidates to improve an evolving subset from which the eventual search results or solution set will be selected. According to a preferred embodiment, the designer can use the interactive display interface to interactively stop the iterative design (optimization) process.

The preferred embodiment includes an optimizer that operates on the stored direct representations. However, this is not necessary to the practice of the invention. In other words, the optimizer can, if desired, perform its optimization process on the design circuits after suitably transforming candidate designs into an alternative representation that need not be in direct correspondence with the direct representation of the database. It must, however, be able to transform in both directions: it must be able to transform the alternative representation back into the direct representation, and the direct representation into the alternative representation.

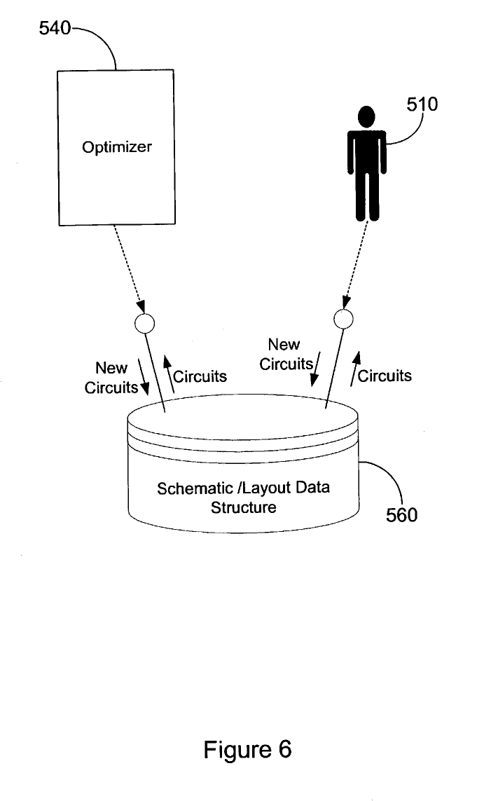

FIG. 6 illustrates conceptually the interactive relationship between manipulation of designs in the database by the designer and the optimizer. Since the optimizer also sees and manipulates the designs in the same database, a change made by the designer during runtime (“on-the-fly”) updates the information made available to the optimizer. Accordingly, the designer 510 can direct or affect the search path or direction of the optimizer. Furthermore, changes made by the optimizer will make corresponding changes to the displays presented to the designer thereby showing the progress made by the optimizer. Changes made by the designer that affect the optimizer will also be displayed to the designer who can see the effects of the changes and make further changes or take other action such as stopping the search and starting again.

FIG. 10 illustrates a corresponding method in accordance with another aspect of the present invention. According to the method, circuit design candidates are represented using direct representations 1010. These direct representations are stored in a storage medium such as a database or a list of data structures (e.g. a netlist) in computer memory (step 1020). Next, new circuit design candidates are generated using the generator of the optimizer (step 1030). An “expanded set” of design candidates is created which includes the current circuit design candidates along with the new design candidates. The selector is used to select one or more preferred design candidates from the expanded set of design candidates and these form the updated current design candidates which are then stored in the storage medium (step 1040). The method continues to generate, select and store design candidates until a stopping criterion is satisfied (step 1050).

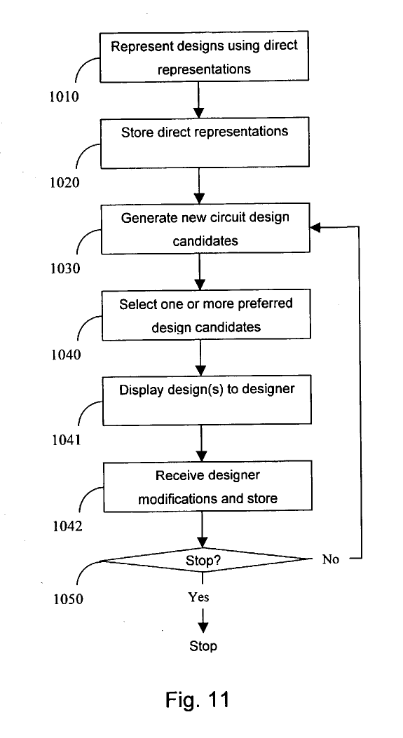

An alternative embodiment is illustrated in FIG. 11 which is similar to FIG. 10 but includes user interactivity by the inclusion of steps 1041 and 1042. In step 1041 views of one or more of the current design candidates are displayed to the designer using an interactive display interface. In step 1042, the designer makes modifications to these displayed design candidates via the interactive display interface, which then stores the modified designs.

Although the present invention is presented in the context of circuit design example, method of the present invention is applicable to many other types of design problems including, for example, design problems relating to digital circuits, scheduling, chemical processing, control systems, neural networks, regression modelling of unknown systems, molecular synthesis, optical circuits, photonics, communications networks, sensors and flow network design problems such as road systems, waterways and other large scale physical networks, optics, mechanical components and opto-electrical components.

Embodiments of the present invention can be implemented as a computer-readable program product, or part of a computer-readable program product, for distribution or integration in suitable software and hardware systems. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art will appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer-readable program product may be distributed as a removable medium with accompanying printed or electronic documentation (e.g., shrink-wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer-readable program product) and hardware. Still other embodiments of the invention may be implemented as entirely hardware, or entirely software (e.g., a computer-readable program product).

Embodiments of the invention may be implemented in any conventional computer programming language. For example, preferred embodiments may be implemented in a procedural programming language (e.g. “C”) or an object oriented language (e.g. “C++”). Alternative embodiments of the invention may be implemented as pre-programmed hardware elements, other related components, or as a combination of hardware and software components.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A system for electronic circuit design comprising:
storage means for storing direct representations of circuit design candidates; a storage means interface for changing the stored direct representation of the design candidates;
an optimizer for determining at least one optimized circuit design candidate, the optimizer capable of altering the stored direct representations by interacting with the storage means interface.

2. The system of claim 1, further comprising an interactive display interface for displaying a view of a circuit design candidate corresponding to a stored direct representation, receiving a command from a designer to modify the direct representations in the storage means, and interacting with the storage means interface for changing the stored direct representations corresponding to the displayed design candidate; and wherein further optimization by the optimizer is responsive to changes in the direct representations from the designer.

3. The system of claim 1, wherein the interface for changing the representation is a database interface.

4. The system of claim 1, wherein the command to modify the displayed design candidate comprises at least one of adding, replacing and deleting a component of the design candidate.

5. The system of claim 1, wherein the optimizer comprises a search algorithm and manipulates at least one of a topology, parameters and placement and routing of a circuit design.

6. The system of claim 1, wherein the optimizer modifies one or more design candidates in the database.

7. The system of claim 1, wherein the optimizer modifies the one or more design candidates by interacting with the database interface which changes the stored direct representations of the circuit design candidate.

8. The system of claim 1, wherein the optimizer proposes new circuit design candidates.

9. The system of claim 2, wherein the optimizer accepts design proposals that a designer has input via the interface for manipulation of the displayed circuit design.

10. The system of claim 9, wherein the optimizer evaluates all candidate designs.

11. The system of claim 10, wherein the optimizer proposes the new candidate designs based on an evaluation of objective function values of candidate designs.

12. The system of claim 2, wherein the interactive display interface comprises a plurality of interactive display interfaces, each interactive display interface corresponding to a different view of the circuit design.

13. The system of claim 1, wherein the circuit design candidates are AMS circuit design candidates.

14. A method of electronic circuit design using an optimizer, the optimizer having a generator and a selector, the method comprising:
(a) representing initial circuit design candidates using direct representations;
(b) storing the direct representations of the circuit design candidates in a storage medium as the current design candidates;
(c) generating, using the generator, a set of new design candidates based on the current circuit design candidates to create an expanded set of design candidates, the expanded set of design candidates comprising the union of the new design candidates and the current design candidates;
(d) selecting, using the selector, one or more preferred design candidates from the expanded set of design candidates, to create a new set of current design candidates;
(e) storing the current design candidates in a storage medium; and
(f) continuing to perform steps ((c)) to ((e)) until a stopping criterion is satisfied.

15. The method of claim 14, further comprising, immediately prior to step (f),:
(a) displaying a view of one or more of the current design candidates circuit design to a designer using an interactive display interface; and
(b) receiving modifications to one or more of the displayed design candidates from the designer via the interactive display interface, and storing the modified designs accordingly.

16. The method of claim 14, wherein the circuit design candidates are AMS circuit design candidates.

17. The method of claim 14, wherein the storage medium is a database.

18. The method of claim 14, wherein the storage medium is a list of data structures residing in computer memory.

19. A method of engineering design using an optimizer, the optimizer having a generator and a selector, the method comprising:
(a) representing initial engineering design candidates using direct representations;
(b) storing the direct representations of the engineering design candidates in a storage medium as the current design candidates;
(c) generating, using the generator, a set of new design candidates based on the current design candidates to create an expanded set of design candidates, the expanded set of design candidates comprising the union of the new design candidates and the current design candidates;
(d) selecting, using the selector, one or more preferred design candidates from the expanded set of design candidates, to create a new set of current design candidates;
(e) storing the current design candidates in a storage medium; and
(f) continuing to perform steps (c) to (e) until a stopping criterion is satisfied.

20. The method of claim 19, wherein engineering design comprises one of: digital circuit design, scheduling design, chemical processing design, control systems design, neural networks design, design of regression models of unknown systems, design of molecular topologies, optical circuit design, photonics design, communications network design, sensor design, and flow network design, road system design, waterway designs, mechanical component designs, and design of opto-electrical components.
